(19) United States
(12) Patent Application Publication
(10) Pub. No.: US 2011/0021093 A1
(43) Pub. Date: Jan. 27, 2011

(54) CONDUCTOR OF PLUG, SOCKET OR CONNECTOR THAT IS IMPROVED BY CONDUCTING MATERIAL

(76) Inventor: Shihuang Li, Xiamen (CN)

Correspondence Address: RABIN & Berdo, PC, 1101 14TH STREET, NW, SUITE 500, WASHINGTON, DC, 20005, US

(21) Appl. No.: 12/745,287

(22) PCT Filed: Mar. 27, 2008
(86) PCT No.: PCT/CN08/00608

§ 371 Date: Aug. 30, 2010

(30) Foreign Application Priority Data
Nov. 28, 2007 (CN) 200710009915.9

(51) Int. Cl. H01R 13/02

(52) U.S. Cl. 439/887

(57) ABSTRACT

A conductor of plug, socket or connector is provided. The substrate of the conductor is steel and the conductor is obtained by plating a coating of Ni on the substrate, and then plating Cu on the outer surface of the substrate by electrolyzing or electrodepositing with using the substrate as the cathode. Alternatively, the substrate of the conductor is stainless steel, and the conductor is obtained by cladding Cu directly on the columnar stainless steel substrate.

### FIELD OF THE INVENTION

The present invention relates to a conductor of plug, socket or connector that is improved by conductive material.

### BACKGROUND OF THE INVENTION

The present conductor of the plug, socket or connector is usually made of Cu, because Cu has good conductivity and low temperature; besides, the material of the conductor of the plug, socket or connector should satisfy the requirements that it has certain strength and can be simply processed. Therefore, Zn or other materials should be fused into Cu material that is used to make the conductor of the plug, socket or connector in order to increase the strength and improve the working performance. 59 brass and 60 brass are used to make the conductor of is the plug, socket or connector, but red copper of high purity is not used. However, copper products are required to have high purity of 99.9% in material companies, and in electrical appliance industry companies, copper products of high purity need to be added into other materials in order to get brass of low purity which would be processed into the copper material for electrical appliances. Owing to the price of copper products increasing greatly, the cost of the copper plug, socket or connector rises. The technology of making brass into plug, socket or connector is a cut method, and copper cuttings can be reused in order to lower the manufacturing cost. But in the method, the reused copper cuttings is limited; the production of red copper of high purity and the use of brass of lower purity is an important reason of the high cost of the copper plug, socket or connector.

### SUMMARY OF THE INVENTION

The purpose of the present invention is to improve the structure of the plug, socket or connector, and combine the improved structure with electrolyzing or electrodepositing of making copper products in order to directly dispose electrolytic copper with the on the substrate of the plug, socket or connector.

A conductor of plug comprises a columnar steel substrate, and a coating of Ni or Cu is plated on the outer surface of the substrate, and then the Cu is plated on the outer surface of the substrate by electrolyzing or electrodepositing with using the substrate as the cathode. Alternatively, the substrate of the conductor is stainless steel, and the conductor is obtained by cladding Cu directly on the columnar stainless steel substrate.

One end of said conductor which is a little larger is touch end, and the other end which has a convex part is a welding end for conducting power.

Said convex part is made by upsetting.

The cross section of the coating of said electrolyzing Cu is more than 5% of the cross section of said columnar steel substrate; 10-30% is better; 20% is best.

Said conductor of plug, socket or connector also comprises said substrate which is covered by a coating of Cu and is processed by surface shaping.

A rotary frame is the cathode in the production of electrolytic copper or electro-deposit copper, said substrate of plug is inserted into said rotary frame in order that the outer surface can be electroplated completely.

A conductor of socket or connector comprises a tabular stainless steel substrate or a tabular steel substrate, and a coating is plated on the outer surface of the substrate, and then the Cu is plated on the single side or double sides of conductive surface of the substrate by electrolyzing or electrodepositing with using the substrate as the cathode. Said tabular substrate which is obtained by cladding Cu is processed to be bent in order to be a conductor of socket or connector.

Alternatively, a conductor of plug, socket or connector may comprise an irregularly shaped stainless steel substrate or a tabular steel substrate, and a coating is plated on the outer surface of the substrate, and then the Cu is plated on the single side or double sides of conductive surface of the substrate by electrolyzing or electrodepositing with using the substrate as the cathode. Said tabular substrate which is obtained by cladding Cu is processed to be bent in order to be a conductor of socket or connector.

The cross section of the coating of said electrolyzing Cu is more than 5% of the cross section of said tabular substrate; 10-30% is better; 20% is best.

Said method of distilling Cu from mineral deposit of mixed type and cladding Cu on the outer surface of substrate is: copper sulfide mineral and copper oxide mineral are respectively broken into eligible pieces; said eligible pieces of said copper oxide mineral is processed by bacteria heap leaching; and eligible copper oxide mineral should be firstly washed and separated, and then mineral sludge and mineral sands are processed by agitation leaching and heap leaching; leach liquor is extracted, and then extracted loaded organic phase is back-extracted and electrodeposited in turn in order to obtain the cathode Cu of high purity which is plated on the outer surface of the plug, socket or connector of the cathode.

In the present invention, said conductor of plug, socket or connector can be changed into two parts, a Cu conductor and a steel substrate, and the advantages of said parts can be made full of when they are working. When said conductor of plug, socket or connector is conducting power, said coating of Cu can increase the conductivity; said steel substrate can improve the mechanical property of said conductor of plug, socket or connector; in the production of Cu by wet process, said steel substrate and Cu are combined and can be used as the cathode in electrodepositing in order to leave out the electroplating procedure.

According to theoretical calculation, when Cu and steel are combined together, if the cross section of Cu takes up 18% of the cross section, the conductivity value can reach that of brass, but the Cu content of brass is 59-62%. So a significant amount of Cu is saved. In the present invention, the conductive Cu on the substrate of the conductor of plug, socket or connector is of high purity, and its conductivity and heat dispersion are both better than that of the conventional brass conductor. Besides, the mechanical property of the conductor of plug, socket or connector is better than the conventional brass conductor, for example the substrate of the conductor is stainless steel so that its elasticity is excellent. The method adopted in the present invention is that plating Cu on the outer surface of the steel substrate or the stainless steel substrate, and the coating of Cu is of high purity, and its conductivity and heat dispersion are both better than brass. Besides, the cost is lower, and the steel material is simply processed, and especially the wet process to produce Cu and the process of cladding Cu on the substrate are combined in order to avoid the electroplating or electrodepositing procedure, as a result of high work efficiency.

### BRIEF DESCRIPTION OF THE DRAWINGS

FIG. 1 is a schematic diagram of a three-pin plug in the present invention.

FIG. 2 is a schematic diagram of a double-pin plug in the present invention.

FIG. 3 is a sectional view of the conductor of the plug in FIG. 1.

FIG. 4 is a sectional view of the conductor of the plug in FIG. 2.

FIG. 5 is a structure view of the conductor of the plug in FIG. 2.

FIG. 6 is a schematic diagram of a socket in the present invention.

FIG. 7 is a sectional view of the conductor of the socket in FIG. 6.

### DESCRIPTION OF SPECIFIC EMBODIMENTS

### Embodiment 1

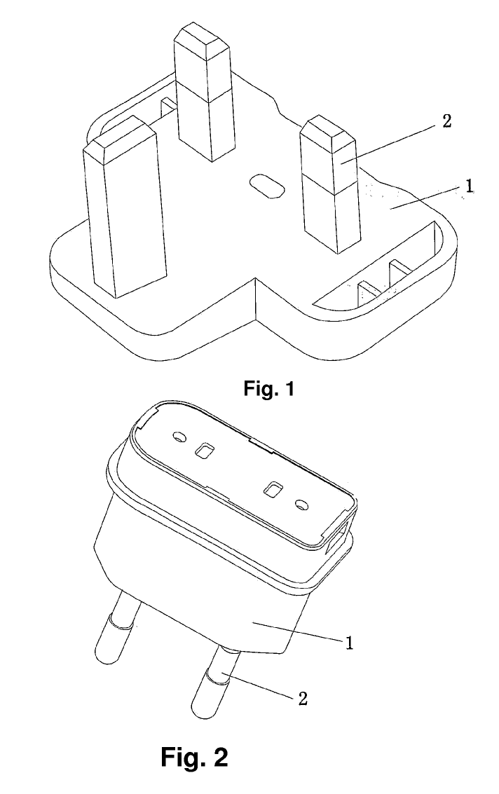

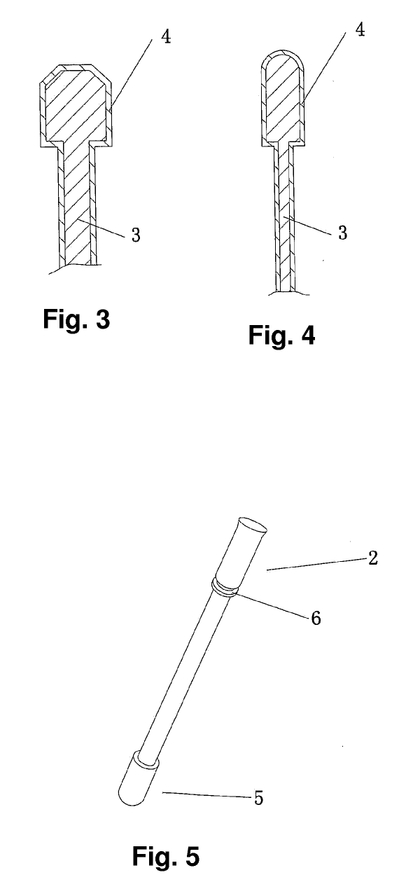

Referring to FIG. 1 to 4, the plug in the embodiment is three-pin plug or double-pin plug, which comprises a plug body (1) and a plug conductor (2), and the plug conductor (2) comprises a steel substrate (3) and a coating of Cu (4) which takes up 20% of the cross section of the columnar substrate. Referring to FIG. 5, a convex part (5) on the front end of the plug conductor (2) is inserted into a socket and then conducts power. And the other end has a convex ring (6) is used to be welded to conductive line or to be connected to other components.

In the embodiment, the diameter and length of the steel substrate, which is used for electrodepositing Cu in wet process, are respectively 2.8 mm and 40 mm, and coating of Cu takes up 20% of the cross section. The following comparison of the conductivities of brass plug conductor and the coating of Cu in the embodiment is:

| | | | Temperature (room |
|---|---|---|---|
| | | contact | temperature is |
| | Electric resistance | resistance | 24.2) |
| brass | 0.485 mΩ | 1.6 mΩ | 29.5 |
| coating of Cu | 0.235 mΩ | 1.2 mΩ | 27.4 |

Obviously, the present invention is superior.

### Embodiment 2

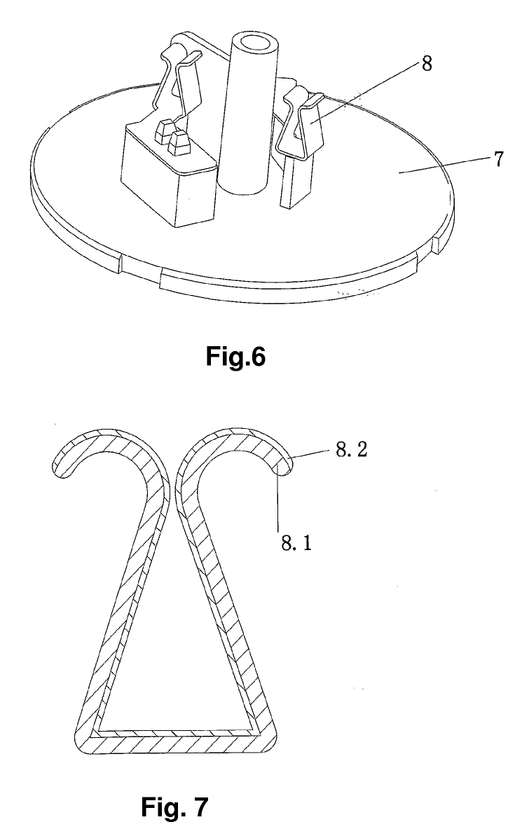

The structure of the socket in the present invention is illustrated in FIG. 6 and FIG. 7, and comprises a socket body (7) and a conductive clamping piece (8) which is fixed to the socket body (7) and is connected to the conductive line. The body of the conductive clamping piece (8) is a stainless steel substrate (8.1), and Cu (8.2) is plated on the surface of the conductive clamping piece (8) contacting the plug, and the cross section of Cu takes up 10-30% of that of the substrate (8.1).

### INDUSTRIAL APPLICABILITY

The conductive Cu on the conductive substrate of plug, socket or connector is has better conductivity and better heat dispersion than that of brass conductor. Besides, the mechanical property of the conductor of plug, socket or connector is better, and a significant amount of Cu is saved, so the present invention has a good industrial applicability.

1. A conductor of plug comprises a columnar steel substrate, and a coating of Ni or Cu is plated on the outer surface of the substrate, and then the Cu is plated on the outer surface of the substrate by electrolyzing or electrodepositing with using the substrate as the cathode; alternatively, the substrate of the conductor is stainless steel, and the conductor is obtained by cladding Cu directly on the columnar stainless steel substrate.

2. Said conductor of plug according to claim 1, wherein one end of said conductor which is a little larger is touch end, and the other end which has a convex part is a welding end for conducting power.

3. Said conductor of plug according to claim 2, wherein said convex part is made by upsetting.

4. Said conductor of plug according to claim 3, wherein the cross section of the coating of said electrolyzing Cu is more than 5% of the cross section of said columnar steel substrate.

5. Said conductor of plug according to claim 4, wherein the cross section of the coating of said electrolyzing Cu is 20% of the cross section of said columnar steel substrate.

6. Said conductor of plug according to claim 5, wherein said conductor of plug, socket or connector also comprises said substrate which is covered by a coating of Cu and is processed by surface shaping.

7. Said conductor of plug according to claim 5, wherein a rotary frame is the cathode in the production of electrolytic copper or electro-deposit copper, said substrate of plug is inserted into said rotary frame in order that the outer surface can be electroplated completely.

8. Said conductor of plug according to claim 5, wherein said method of distilling Cu from mineral deposit of mixed type and cladding Cu on the outer surface of substrate is: copper sulfide mineral and copper oxide mineral are respectively broken into eligible pieces; said eligible pieces of said copper oxide mineral is processed by bacteria heap leaching; and eligible copper oxide mineral should be firstly washed and separated, and then mineral sludge and mineral sands are processed by agitation leaching and heap leaching; leach liquor is extracted, and then extracted loaded organic phase is back-extracted and electrodeposited in turn in order to obtain the cathode Cu of high purity which is plated on the outer surface of the plug which is used as the cathode.

9. A conductor of socket or connector, wherein it comprises a tabular stainless steel substrate or a tabular steel substrate, and a coating is plated on the outer surface of the substrate, and then the Cu is plated on the single side or double sides of conductive surface of the substrate by electrolyzing or electrodepositing with using the substrate as the cathode, said tabular substrate which is obtained by cladding Cu is processed to be bent in order to be a conductor of socket or connector.

10. A conductor of socket or connector, wherein it comprises an irregularly shaped stainless steel substrate or a tabular steel substrate, and a coating is plated on the outer surface of the substrate, and then the Cu is plated on the single side or double sides of conductive surface of the substrate by electrolyzing or electrodepositing with using the substrate as the cathode, and said tabular substrate which is obtained by cladding Cu is processed to be bent in order to be a conductor of socket or connector.

11. Said conductor of socket or connector according to claim 9, wherein the cross section of the coating of said electrolyzing Cu is more than 5% of the cross section of said tabular substrate.

12. Said conductor of socket or connector according to claim 11, wherein the cross section of the coating of said electrolyzing Cu is 20% of the cross section of said tabular substrate.

13. Said conductor of socket or connector according to claim 9, wherein said method of distilling Cu from mineral deposit of mixed type and cladding Cu on the outer surface of substrate is: copper sulfide mineral and copper oxide mineral are respectively broken into eligible pieces; said eligible pieces of said copper oxide mineral is processed by bacteria heap leaching; and eligible copper oxide mineral should be firstly washed and separated, and then mineral sludge and mineral sands are processed by agitation leaching and heap leaching; leach liquor is extracted, and then extracted loaded organic phase is back-extracted and electrodeposited in turn in order to obtain the cathode Cu of high purity which is plated on the outer surface of the plug, socket or connector which is used as the cathode.

14. Said conductor of socket or connector according to claim 10, wherein the cross section of the coating of said electrolyzing Cu is more than 5% of the cross section of said tabular substrate.

15. Said conductor of socket or connector according to claim 14, wherein the cross section of the coating of said electrolyzing Cu is 20% of the cross section of said tabular substrate.

16. Said conductor of socket or connector according to claim 10, wherein said method of distilling Cu from mineral deposit of mixed type and cladding Cu on the outer surface of substrate is: copper sulfide mineral and copper oxide mineral are respectively broken into eligible pieces; said eligible pieces of said copper oxide mineral is processed by bacteria heap leaching; and eligible copper oxide mineral should be firstly washed and separated, and then mineral sludge and mineral sands are processed by agitation leaching and heap leaching; leach liquor is extracted, and then extracted loaded organic phase is back-extracted and electrodeposited in turn in order to obtain the cathode Cu of high purity which is plated on the outer surface of the plug, socket or connector which is used as the cathode.
